(19) United States
(12) Patent Application Publication
(10) Pub. No.: US 2015/0116372 A1
(43) Pub. Date: Apr. 30, 2015

(54) APPARATUS FOR CONTROLLING GRID OUTPUT IN A MOBILE DEVICE AND METHOD FOR CONTROLLING GRID OUTPUT USING THE SAME

(71) Applicant: TOBESOFT CO.,LTD, Seoul (KR)

(72) Inventors: Hwajun Song, Seoul (KR); Woocheol Lee, Seoul (KR)

(21) Appl. No.: 14/507,845

(22) Filed: Oct. 7, 2014

(30) Foreign Application Priority Data
Oct. 25, 2013 (KR) 10-2013-0128075

(51) Int. Cl. G09G 5/34; G06T 3/20

(52) U.S. Cl. CPC G09G 5/34; G06T 3/20; G09G 2354/00; G09G 2340/0471
USPC 345/687

(57) ABSTRACT

The method includes generating a grid having a plurality of rows and displaying the grid on a display of a mobile device by a grid generator, sensing movement of a row of the grid, measuring a scrolling speed with respect to a speed of the row of the grid, and generating speed information based on the measured scrolling speed by a grid movement sensor, generating a grid create signal for a grid create command at every predetermined period by a grid create signal generator, and upon receipt of the grid create signal after the grid is generated, generating a new grid to be displayed on the display using the speed information by the grid generator.

### CROSS REFERENCE TO PRIOR APPLICATION

This application claims the benefit of Korean Patent Application No. 10-2013-0128075, filed on Oct. 25, 2013, which is hereby incorporated by reference as if fully set forth herein.

### BACKGROUND OF THE INVENTION

1. Field of the Invention

The present invention relates to an apparatus for controlling a grid output in a mobile device and a method for controlling a grid output using the same, and more particularly, to an apparatus for controlling a grid output in a mobile device and a method for controlling a grid output using the same, which generate and display a new grid, starting from a row apart from the last row of a grid displayed on a display of the mobile device by a predetermined number of rows using a scrolling speed with respect to a speed of the grid displayed on the display, so that rows of the grid may be perceived as moving on the display in accordance with the scrolling speed.

2. Discussion of the Related Art

Owing to reinforcement of network infrastructure, the increasing use of the Internet, and the development of mobile communication technology, communication service is available irrespective of time and place. Particularly, as mobile devices providing communication service, such as smartphones, have recently been developed, users can use a Web server by connecting to the Internet through their mobile devices at any time in any place.

Various types of information exist in Web servers on the Internet. For example, a Web server may have grid information in which various pieces of information are arranged. A mobile device may receive grid information along with information about a screen of the Web server, generate the screen and a grid of the Web server, and display the generated screen and grid on a display.

Conventionally, a mobile device loads total rows and contents corresponding to each of lattices arranged in the total rows using grid information received from a Web server, renders a grid with a predetermined rows matching to a screen size of a display, and displays the grid on the display.

If a row of the grid moves, the mobile device should render a new grid on the display. As the mobile device has lower capabilities, it takes more time to render a new grid on the display. That is, a mobile device with lower capabilities has limitations in generating a new grid in accordance with a high scrolling speed with respect to a speed of a row of a grid. As a result, the effect of tricking a user into perceiving a grid of rows as moving on the display is not achieved.

Accordingly, techniques that make a row of a grid appear moving in accordance with a high scrolling speed even in a low-capability mobile device are under development.

### SUMMARY OF THE INVENTION

Accordingly, the present invention is directed to an apparatus for controlling a grid output in a mobile device and a method for controlling a grid output using the same that substantially obviate one or more problems due to limitations and disadvantages of the related art.

An object of the present invention is to provide an apparatus for controlling a grid output in a mobile device and a method for controlling a grid output using the same, which can display a row of a grid in such a manner that the row of the grid may be perceived as moving, despite a high scrolling speed with respect to a speed of the row of the grid.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for controlling a grid output includes generating a grid having a plurality of rows and displaying the grid on a display of a mobile device by a grid generator, sensing movement of a row of the grid, measuring a scrolling speed with respect to a speed of the row of the grid, and generating speed information based on the measured scrolling speed by a grid movement sensor, generating a grid create signal for a grid create command at every predetermined period by a grid create signal generator, and upon receipt of the grid create signal after the grid is generated, generating a new grid to be displayed on the display using the speed information by the grid generator. The grid generator generates the new grid, starting from a row apart from a last row of the grid previously generated and displayed on the display, based on the speed information and a time of generating the received grid create signal.

The generating and displaying of a grid on a display of a mobile device may include generating a plurality of lattices arranged in the plurality of rows of the grid by a lattice generator, displaying contents corresponding to each of the plurality of lattices in the lattice of the grid by a content output unit, and displaying the plurality of lattices of the grid and the contents corresponding to each of the plurality of lattices on the display by the grid generator.

The contents corresponding to each of the plurality of lattices may be one of text, an image, and a button.

The generation of a new grid to be displayed on the display may include generating a plurality of lattices arranged in a plurality of rows of the new grid by a lattice generator, displaying contents corresponding to each of the plurality of lattices in the lattice of the new grid by a content output unit, and displaying the plurality of lattices of the new grid and the contents corresponding to each of the plurality of lattices on the display by the grid generator.

The grid generator may repeat the generation of a new grid to be displayed on the display until a scrolling speed based on the speed information and the received grid create signal is zero.

The method for outputting a grid output may be recorded in a computer-readable recording medium.

In another aspect of the present invention, an apparatus for controlling a grid output in a mobile device includes a grid movement sensor for sensing movement of a row of a grid, measuring a scrolling speed with respect to a speed of the row of the grid, and generating speed information based on the measured scrolling speed, a grid create signal generator for generating a grid create signal for a grid create command at every predetermined period, and a grid generator for generating a grid having a plurality of rows, displaying the grid on a display of the mobile device, and upon receipt of the grid create signal after the grid is generated, generating a new grid to be displayed on the display using the speed information. The grid generator generates the new grid, starting from a row apart from a last row of the grid previously generated and displayed on the display, based on the speed information and a time of generating the received grid create signal.

The grid generator may include a lattice generator for generating a plurality of lattices for a grid, and a content output unit for displaying contents corresponding to each of the plurality of lattices.

The contents corresponding to each of the plurality of lattices may be one of text, an image, and a button.

The gird generator may repeat the generation of a new grid to be displayed on the display until a scrolling speed based on the speed information and the received grid create signal is zero.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a mobile device having an apparatus for controlling a grid output according to an embodiment of the present invention;

FIG. 2 is a block diagram of an apparatus for controlling a grid output in a mobile device according to an embodiment of the present invention;

FIG. 3 is a flowchart illustrating a method for controlling a grid output according to an embodiment of the present invention; and

FIG. 4 illustrates a screen displaying a new grid on a display in view of movement of an existing grid.

### DETAILED DESCRIPTION OF THE INVENTION

The objectives and effects of the present invention and the technical configurations of the present invention to achieve them will be apparent with reference to embodiments of the present invention described in detail with the attached drawings. A detailed description of a generally known function and structure of the present invention will be avoided lest it should obscure the subject matter of the present invention. Although the terms used in the present invention are selected from generally known and used terms, taking into account the structures, roles, and functions of the present invention, they are subject to change depending on the intention of a user or an operator or practices.

It is to be clearly understood that the present invention may be implemented in various manners, not limited to embodiments as set forth herein. The embodiments of the present invention are provided only to render the disclosure of the present invention comprehensive and indicate the scope of the present invention to those skilled in the art. The present invention is defined only by the appended claims. Accordingly, the scope of the invention should be determined by the overall description of the specification.

Through the specification, when it is said that some part “includes” a specific element, this means that the part may further include other elements, not excluding them, unless otherwise mentioned. The terms “unit”, “part” and “module” used herein indicate a unit that executes at least one function or operation and may be implemented in hardware, software, or both.

In embodiments of the present invention, each component, function block, or means may be configured with one or more sub-components. Electrical, electronic, and mechanical functions performed by each component may be implemented into various known devices or mechanical elements such as electronic circuits, integrated circuits, or Application Specific Integrated Circuits (ASICs). Components may be configured separately or two or more components may be incorporated into a single component.

Combinations of blocks in the attached block diagrams and steps in the attached flowchart may be performed by computer program instructions. Since these computer program instructions may be loaded on a processor of a mobile device such as a smartphone, instructions performed by a processor of data processing equipment generate a means for performing functions described in each block or step in the block diagrams or flowchart which will be described below.

In addition, each block or each step may represent a part of a module, segment, or code that contains one or more executable instructions to execute a specific logical function(s). It is to be noted that functions mentioned in blocks or steps take place in a different order in some alternative embodiments. For example, two consecutive blocks or steps may be performed substantially at the same or in reverse order depending on corresponding functions.

With reference to the attached drawings, an apparatus and method for controlling a grid output in a mobile device according to embodiments of the present invention will be described below in detail.

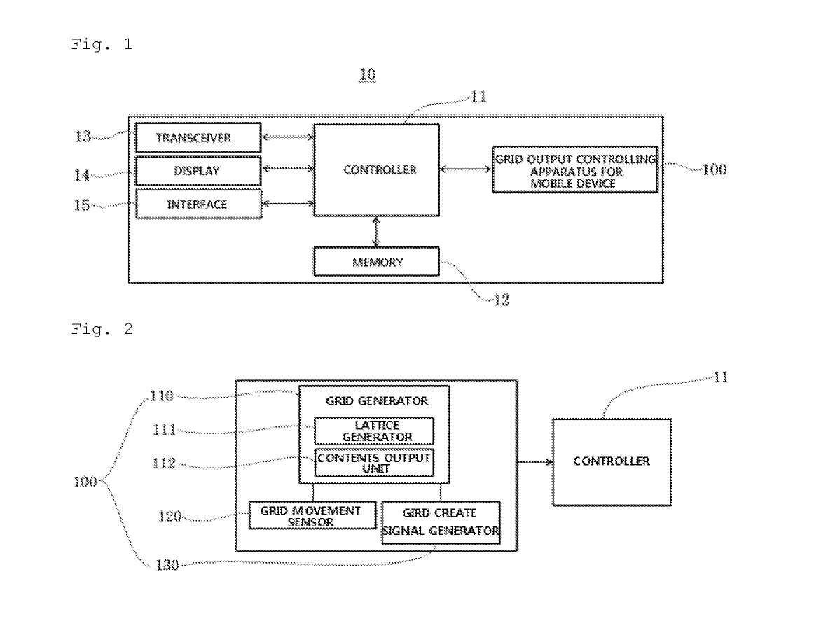

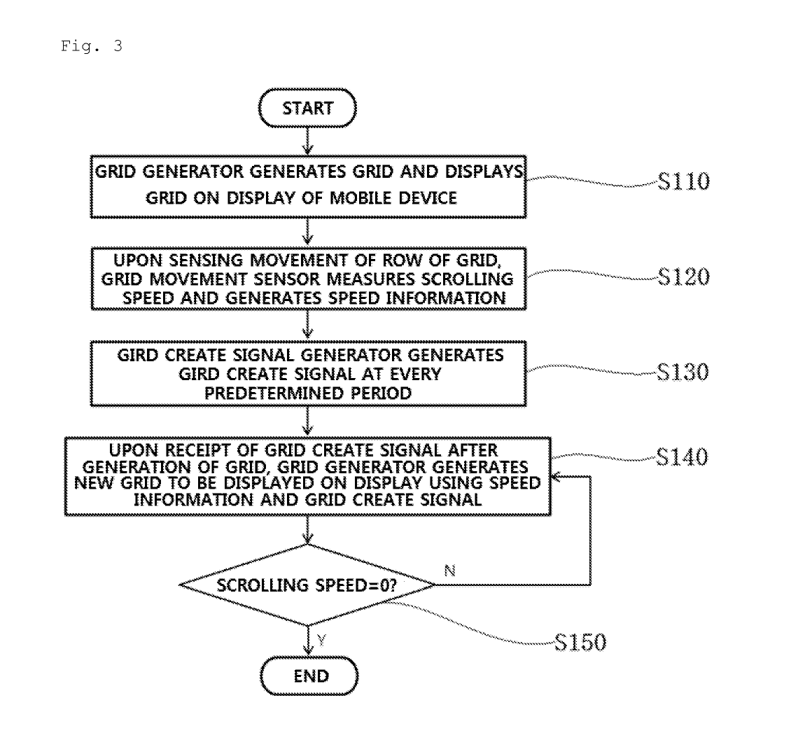

FIG. 1 is a block diagram of a mobile device 10 having a grid output controlling apparatus 100 according to an embodiment of the present invention, and FIG. 2 is a block diagram of the grid output controlling apparatus 100 for a mobile device according to the embodiment of the present invention.

Referring to FIGS. 1 and 2, the mobile device 10 may enable a user to view various types of information provided by a Web server by connecting to the Internet. The mobile device 10 may be a device having communication capabilities, such as a smartphone, a tablet Personal Computer (PC), or the like. The mobile device 10 may include a controller 11 that provides overall control to the mobile device 10, a memory 12 that is electrically connected to the controller 11 and stores grid information received from a Web server, a transceiver 13 that is electrically connected to the controller 11 and transmits and receives specific information to and from the Web server, a display 14 that is electrically connected to the controller 11 and displays information received from the Web server and a grid generated from the later-described grid output controlling apparatus 100, and an interface 15 that is electrically connected to the controller 11 and serves as an input means.

The grid output controlling apparatus 100 for a mobile device may be electrically connected to the controller of the mobile device 10. The grid output controlling apparatus 100 may receive the grid information stored in the memory 12 from the controller 11, generate a grid using the grid information, and display the generated grid on the display 14. The grid output controlling apparatus 100 may generate a new grid and display the new grid on the display 14, starting from a row apart from the last row of the displayed grid by a predetermined number of rows, according to a scrolling speed with respect to a speed at which a row of the grid displayed on the display 14 moves through manipulation of the interface unit 15.

The grid output controlling apparatus 100 may include a grid generator 110, a grid movement sensor 120, and a grid create signal generator 130.

The grid generator 110 may generate a grid using the grid information received from the controller 11. The grid generator 110 may include a lattice generator 111 for generating a plurality of lattices in the grid displayed on the display 14 using the grid information and a contents output unit 112 for displaying corresponding contents in each of the plurality of lattices. The grid generator 110 may generate a grid through the lattice generator 111 and the contents output unit 112 and display the grid on the display of the mobile device 10. The grid generator 110 may generate a new grid and display the new grid on the display 14, starting from a row apart from the last row of the grid displayed on the display 14 by a predetermined number of rows, using speed information generated from the grid movement sensor 120 that has sensed movement of a row of the displayed grid and a grid create signal generated from the grid create signal generator 130. A method for generating a grid and displaying the grid on the display 14 by the grid generator 110 will be described later in detail in connection with a method for controlling a grid output according to an embodiment of the present invention.

The grid movement sensor 120 may sense movement of a row of the grid that has been displayed on the display 14 by the grid generator 110. If a row of the grid moves, the grid movement sensor 120 may measure a scrolling speed with respect to a speed of the row of the grid and generate speed information based on the measured scrolling speed. Also, the grid movement sensor 120 may provide the generated speed information to the grid generator 110.

The gird create signal generator 130 may generate a grid create signal for a grid create command at every predetermined period from the moment when the speed information is generated from the grid movement sensor 120. The grid create signal may include time information specifying a time of generating the grid create signal. The grid create signal generator 120 may provide the grid create signal periodically to the grid generator 110.

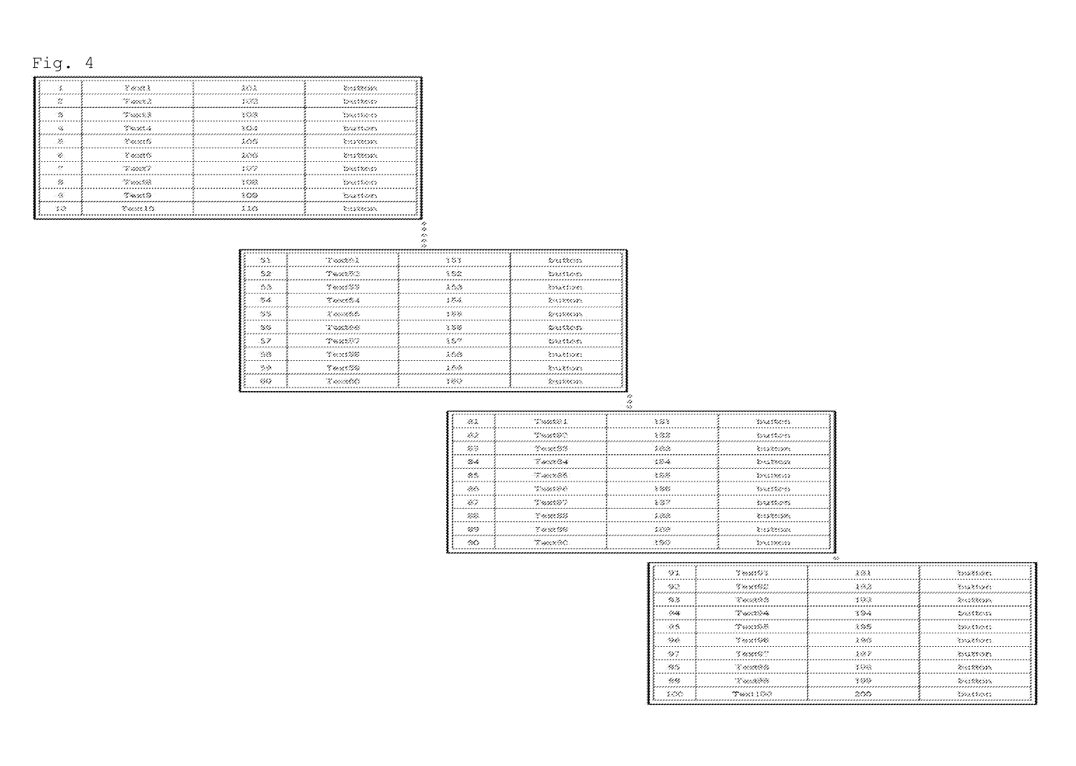

Now a detailed description will be given of a method for displaying a gird on the display 14 of the mobile device 10 with reference to FIG. 3 illustrating a flowchart of a method for controlling a grid output according to an embodiment of the present invention.

Referring to FIG. 3, the grid generator 110 generates a grid and displays the gird on the display 14 of the mobile device 10 (S110). Herein, the mobile device 10 may receive grid information from a Web server and store the received grid information in the memory 12 and the grid generator 110 may receive the grid information from the controller 11 of the mobile device 10. The grid generator 110 may generate a grid having a predetermined number of rows matching to a screen size of the display 14 from among total rows and contents corresponding to respective lattices arranged in the total rows, which are included in the grid information, using the grid information received from the grid generator 110, and display the generated grid on the display 14. For example, if the grid information includes 100 rows in total and a grid of 10 rows is to be displayed on the display 14, the grid generator 110 may generate a grid having row 1 to row 10 from among the total rows, matching to the screen size of the display 14 and display the generated grid on the display 14 (see FIG. 4).

The grid generator 110 generates a grid to be displayed on the display 14 in the following manner. The lattice generator 111 of the grid generator 110 may generate a plurality of lattices to be arranged in a plurality of rows of a grid using the grid information. The contents output unit 112 of the grid generator 110 may display contents corresponding to the respective lattices in the lattices that have been generated using the grid information by the lattice generator 111. The contents corresponding to each of the lattices may be one of text, an image, or a button for activating a specific function, which should not be construed as limiting the present invention.

The grid generator 110 may display the plurality of lattices generated by the lattice generator 111 and the contents corresponding to the lattices, generated by the contents output unit 112 on the display 14 so that a grid may be displayed on the display 14 of the mobile device 10.

Upon sensing movement of a row of the grid displayed on the display 14, the grid movement sensor 120 measures a scrolling speed with respect to a speed of the row of the grid and generates speed information based on the measured scrolling speed (S120). A row of the grid may be moved by manipulating the interface 15. For example, if the interface 15 is implemented as a touch screen, a row of the grid may be moved in a direction by a touch manipulation of a user. If the interface 15 is implemented as a mouse, a row of the grid may be moved in a direction by moving a scroll bar formed at one side of the grid, which should not be construed as limiting the present invention. The grid movement sensor 120 may measure the scrolling speed with respect to the speed of the row of the grid that moves through manipulation of the interface 15. As the row of the grid moves faster on the display 14, the scrolling speed may be higher. The grid movement sensor 120 may provide the generated speed information to the grid generator 110.

Subsequently, the grid create signal generator 130 generates a grid create signal at every predetermined period (S130). The grid create signal generator 130 may generate the grid create signal at a predetermined period from the moment when the speed information is generated from the grid movement sensor 120 and provide the grid create signal to the grid generator 110. The grid create signal may include information about a time of generating the grid create signal.

The grid generator 110 may receive the periodic grid create signal from the grid create signal generator 130, while generating a grid to be displayed on the display 14. If the mobile device 10 has low capabilities, the grid generator 110 may take more time to generate a grid to be displayed on the display 14 than a time interval at which the grid create signal is generated. While generating the grid, the grid generator 110 of the low-capability mobile device 10 may receive the grid create signal a plurality of times from the grid create signal generator 130. However, the grid generator 110 may be still engaged in generating the on-going grid despite reception of the grid create signal during generation of the grid. That is, even though the grid generator 110 receives the grid create signal during gird generation, the grid generator 110 may not generate a new grid.

Upon receipt of the grid create signal after the grid is generated, the grid generator 110 generates a new grid to be displayed on the display 14 using the speed information and the gird create signal (S140).

A method for generating a new grid by the grid generator 110 will be described in more detail. The grid generator 110 may determine the time of generating the grid create signal from the time information included in the received grid create signal. The grid generator 110 may determine a starting row of the grid to be displayed on the display 14 based on the time of generating the grid create signal and the speed information and set the starting row as a position at which the new grid starts to be generated. As described before, while generating a grid, the grid generator 110 does not generate a new grid even though it receives the grid create signal. Therefore, a grid create signal that the grid generator 110 receives after generating the grid may be a grid create signal that has been generated a predetermined time later in the grid create signal generator 130. That is, the position at which the grid generator 110 starts to generate the new grid may be a row apart from the last row of the grid displayed on the display 14, rather than the row following the last row of the grid. Accordingly, the grid generator 110 may start to generate the new grid at the row apart from the last row of the grid displayed on the display 14 by the predetermined number of rows. For example, if an existing grid with row 1 to row 10 is displayed on the display 14 and the starting position of a new grid is row 51, the grid generator 110 may generate a grid spanning from row 51 to row 60 and display the generated grid on the display 14 (see FIG. 4).

The grid generator 110 generates a new grid to be displayed on the display in the same manner as the afore-described method for generating a grid by the grid generator 110 and thus will not be described herein to avoid redundancy of description.

The grid generator 110 may determine a scrolling speed at the moment of receiving a grid create signal, using the speed information and the grid create signal received after the grid is generated. The grid generator 110 repeats the above-described operation for generating a new grid until the scrolling speed is 0 (S150). As the scrolling speed decreases with passage of time, the number of rows by which the new grid is apart from the grid displayed on the display 14 may be decreased (see FIG. 4).

In the method for controlling a grid output according to the embodiment of the present invention, since the grid generator 110 generates a new grid to be displayed on the display 14, starting from a row apart from the last row of a grid displayed on the display by a predetermined number of rows based on speed information and a grid create signal, rows of the grid displayed on the display may be perceived as moving in accordance with a fast scrolling speed even in a mobile device with low capabilities.

As is apparent from the foregoing description of the apparatus and method for controlling a grid output in a mobile device, since a new grid to be displayed on the display is generated, starting from a row apart from the last of an existing grid displayed on the display by a predetermined number of rows, using a scrolling speed with respect to a speed of a row of the grid displayed on the display, the row of the grid displayed on the display may be perceived as moving in accordance with a high scrolling speed even in a low-capability mobile device.

The proposed method for controlling a grid output may be implemented as computer-readable or smartphone-readable code in a computer-readable or smartphone-readable recording medium. The computer-readable or smartphone-readable recording medium may include any kind of recording device storing computer-readable or smartphone-readable data. Examples of the recording medium may include Read Only Memory (ROM), Random Access Memory (RAM), Compact Disk (CD), Digital Versatile Disk (DVD), Blu-ray disk, magnetic tape, floppy disk, optical data storing device, flash memory, and the like, and may also include the medium that is implemented in the form of carrier waves (for example, transmission over the Internet). In addition, the computer-readable or smartphone-readable recording medium may be distributed over computer systems connected over the network, and computer-readable or smartphone-readable codes may be stored and executed in a distributed manner.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

1. A method for controlling a grid output, the method comprising:
generating a grid having a plurality of rows and displaying the grid on a display of a mobile device by a grid generator;
sensing movement of a row of the grid, measuring a scrolling speed with respect to a speed of the row of the grid, and generating speed information based on the measured scrolling speed by a grid movement sensor;
generating a grid create signal for a grid create command at every predetermined period by a grid create signal generator; and
upon receipt of the grid create signal after the grid is generated, generating a new grid to be displayed on the display using the speed information by the grid generator,
wherein the grid generator generates the new grid, starting from a row apart from a last row of the grid previously generated and displayed on the display, based on the speed information and a time of generating the received grid create signal.

2. The method according to claim 1, wherein the generating and displaying of a grid on a display of a mobile device comprises:
generating a plurality of lattices arranged in the plurality of rows of the grid by a lattice generator;
displaying contents corresponding to each of the plurality of lattices in the lattice of the grid by a content output unit; and
displaying the plurality of lattices of the grid and the contents corresponding to each of the plurality of lattices on the display by the grid generator.

3. The method according to claim 2, wherein the contents corresponding to each of the plurality of lattices are one of text, an image, and a button.

4. The method according to claim 1, wherein the generation of a new grid to be displayed on the display comprises:
generating a plurality of lattices arranged in a plurality of rows of the new grid by a lattice generator;
displaying contents corresponding to each of the plurality of lattices in the lattice of the new grid by a content output unit; and
displaying the plurality of lattices of the new grid and the contents corresponding to each of the plurality of lattices on the display by the grid generator.

5. The method according to claim 1, wherein the grid generator repeats the generation of a new grid to be displayed on the display until a scrolling speed based on the speed information and the received grid create signal is zero.

6. A computer-readable recording medium storing a command for performing the method according to claim 1.

7. An apparatus for controlling a grid output in a mobile device, the apparatus comprising:
a grid movement sensor for sensing movement of a row of a grid, measuring a scrolling speed with respect to a speed of the row of the grid, and generating speed information based on the measured scrolling speed;
a grid create signal generator for generating a grid create signal for a grid create command at every predetermined period; and
a grid generator for generating a grid having a plurality of rows, displaying the grid on a display of the mobile device, and upon receipt of the grid create signal after the grid is generated, generating a new grid to be displayed on the display using the speed information,
wherein the grid generator generates the new grid, starting from a row apart from a last row of the grid previously generated and displayed on the display, based on the speed information and a time of generating the received grid create signal.

8. The apparatus according to claim 7, wherein the grid generator comprises:
a lattice generator for generating a plurality of lattices for a grid; and
a content output unit for displaying contents corresponding to each of the plurality of lattices.

9. The apparatus according to claim 8, wherein the contents corresponding to each of the plurality of lattices are one of text, an image, and a button.

10. The apparatus according to claim 7, wherein the gird generator repeats the generation of a new grid to be displayed on the display until a scrolling speed based on the speed information and the received grid create signal is zero.

11. A computer-readable recording medium storing a command for performing the method according to claim 2.

12. A computer-readable recording medium storing a command for performing the method according to claim 3.

13. A computer-readable recording medium storing a command for performing the method according to claim 4.

14. A computer-readable recording medium storing a command for performing the method according to claim 5.
